(19) United States
(12) Patent Application Publication
(10) Pub. No.: US 2011/0179871 A1
(43) Pub. Date: Jul. 28, 2011

(54) TILT SENSOR UNIT

(75) Inventors: Atsushi MISAWA, Ise-shi (JP); Kazuya NOHARA, Watarai-gun (JP)

(73) Assignee: PANASONIC ELECTRIC WORKS CO., LTD.,, Osaka (JP)

(21) Appl. No.: 13/012,161

(22) Filed: Jan. 24, 2011

(30) Foreign Application Priority Data
Jan. 26, 2010 (JP) 2010-013967
Jul. 5, 2010 (JP) 2010-152757

(51) Int. Cl. G01P 15/125

(52) U.S. Cl. 73/514.32

(57) ABSTRACT

Acceleration sensors and a microcomputer are mounted on a sensor mounting board. At this time, the accelerations sensors are arranged so that, even in the case where any detection axes of the acceleration sensors is made horizontal, the other detection axes of the acceleration sensors cannot be horizontal. Then, the microcomputer selects an acceleration sensor in which detection accuracy is the best from among the acceleration sensors, and arithmetically operates a tilt angle of a tilt sensor unit based on an output signal of the selected acceleration sensor.

### CROSS REFERENCE TO RELATED APPLICATIONS

This application is based upon and claims the benefit of priority from prior Japanese Patent Applications P2010-013967 filed on Jan. 26, 2010 and P2010-152757 filed on Jul. 5, 2010; the entire contents of which are incorporated by reference herein.

### BACKGROUND OF THE INVENTION

The present invention relates to a tilt sensor unit.

Heretofore, as disclosed in Japanese Patent Laid-Open Publication No. 2007-147493 (hereinafter, written as Patent Literature 1), as a tilt sensor unit, one has been known, in which two acceleration sensors are arranged in a vehicle in a state where detection axes thereof are directed in directions different from each other on a horizontal plane.

In this Patent Literature 1, a tilt of the vehicle in a fore-and-aft direction or a tilt thereof in a width direction is always detected by two acceleration sensors, whereby a tilt angle of the vehicle is calculated accurately.

### SUMMARY OF THE INVENTION

Incidentally, in the case of detecting the tilt angle by using one acceleration sensor, it is general that detection accuracy of the acceleration sensor is decreased when the tilt angle is increased.

Specifically, in the case of using one acceleration sensor, an accurately detectable tilt angle is limited to a narrow range.

Moreover, in such a structure that always detects the tilt angle by using two acceleration sensors as in the above-described conventional technology, an action thereof is equivalent to the detection of the tilt angle by using one acceleration sensor, and in the same way as above, the accurately detectable tilt angle is limited to the narrow range.

In this connection, it is an object of the present invention to obtain a tilt sensor unit capable of accurately detecting the tilt angle over a wider range.

In order to achieve the foregoing object, the present invention is a tilt sensor unit including: a detection unit that outputs an output signal corresponding to a tilt angle; and a signal processing unit that arithmetically operates the tilt angle based on the output signal of the detection unit, wherein a plurality of the detection units are arranged, and in addition, at least two detection units among the plurality of detection units are arranged so that detection axes thereof can be directed in directions different from each other, the detection units arranged so that the detection axes can be directed in the directions different from one another are arranged so that, even in a case where any of the detection axes of the detection units is made horizontal, other detection axes of the detection units cannot be horizontal in a state where the tilt sensor unit is enabled to detect the tilt angle, and the signal processing unit arithmetically operates the tilt angle based on an output signal of a detection unit in which, a detection axis is nearest a horizon among the detection units arranged so that the detection axes can be directed in the directions different from one another.

Moreover, the present invention is a tilt sensor unit including: a detection unit that outputs an output signal corresponding to a tilt angle; and a signal processing unit that arithmetically operates the tilt angle based on the output signal of the detection unit, wherein a plurality of the detection units are arranged, and in addition, at least two detection units among the plurality of detection units are arranged so that detection axes thereof can be directed in directions different from each other, the detection units arranged so that the detection axes can be directed in the directions different from one another are arranged so that, even in a case where any of the detection axes of the detection units is made horizontal, other detection axes of the detection units cannot be horizontal in a state where the tilt sensor unit is enabled to detect the tilt angle, and the signal processing unit selects a detection unit in which a detected output signal is within a predetermined range from among the detection units arranged so that the detection axes can be directed in the directions different from one another, and arithmetically operates the tilt angle based on the output signal of the selected detection unit.

### BRIEF DESCRIPTION OF THE DRAWINGS

FIG. 1 is a front view of a sensor mounting board built in a tilt sensor unit according to a first embodiment of the present invention.

FIG. 2 is an exploded perspective view of the tilt sensor unit that builds therein the sensor mounting board shown in FIG. 1.

FIGS. 3(a) to 3(c) are views showing states of sensing a tilt angle by using the tilt sensor unit according to the first embodiment of the present invention: FIG. 3(a) is a front view of the tilt sensor unit when the tilt angle is 0°; FIG. 3(b) is a front view of the tilt sensor unit when the tilt angle is 45°; and FIG. 3(c) is a front view of the tilt sensor unit when the tilt angle is 90°.

FIGS. 4(a) and 4(b) are views showing a board for use in analysis of a warp by a temperature change of the board: FIG. 4(a) is a plan view of the board; and FIG. 4(b) is a partially cutaway side view showing a state where the board is fixed.

FIG. 5 is an explanatory view showing a calculation method of the tilt angle of the board shown in FIGS. 4(a) and 4(b).

FIG. 6 is an explanatory view showing points on the board, which are selected at a time of the analysis of the warp by the temperature change of the board.

FIGS. 7(a) and 7(b) are graphs showing displacement of the board in a Z-direction at a time of changing the temperature: FIG. 7(a) is a graph showing displacement of the board in the Z-direction at a time of selecting points on a centerline thereof; and FIG. 7(b) is a graph showing displacement of the board in the Z-direction at a time of selecting points on a diagonal line thereof.

FIG. 8 is a graph showing tilt angles at the respective points on the centerline of the board at the time of changing the temperature.

FIG. 9 is an explanatory view showing a region of the board shown in FIG. 4(a), in which the warp by the temperature change is small.

FIG. 10 is an explanatory view showing a sensing principle of the acceleration sensor.

FIG. 11 is a graph showing a relationship between a sensor output of the acceleration sensor and an acceleration component.

FIG. 12 is a graph showing a relationship between the sensor output of the acceleration sensor and the tilt angle.

FIG. 13 is a graph showing a relationship between the sensor output of the acceleration sensor and sensitivity thereof.

FIG. 14 is an explanatory view showing output characteristics of first, second and third acceleration sensors mounted on the sensor mounting board shown in FIG. 1.

FIG. 15 is a table showing detection ranges of the tilt angle by the first, second and third acceleration sensors mounted on the sensor mounting board shown in FIG. 1.

FIGS. 16(a) and 16(b) are views explaining a configuration of the tilt sensor unit according to the first embodiment of the present invention: FIG. 16(a) is a block diagram showing a power feed system; and FIG. 16(b) is a block diagram showing a sensor system.

FIG. 17 is a front view of a sensor mounting board built in a tilt sensor unit according to a second embodiment of the present invention.

FIG. 18 is a perspective view of the sensor mounting board shown in FIG. 17.

FIG. 19 is an exterior perspective view of the tilt sensor unit that builds therein the sensor mounting board shown in FIG. 17.

FIG. 20 is an explanatory view showing output characteristics of first, second and third acceleration sensors mounted on the sensor mounting board shown in FIG. 17.

### DETAILED DESCRIPTION OF THE PREFERRED EMBODIMENTS

A description is made below of embodiments of the present invention while referring to the drawings. Note that similar constituent elements are included in a plurality of the following embodiments. Hence, in the following, common reference numerals are assigned to these similar constituent elements, and duplicate description is omitted.

### First Embodiment

A tilt sensor unit 1 according to this embodiment includes: detection units 8 which output output voltages (output signals) corresponding to a tilt angle; and a microcomputer (signal processing unit) 5 that arithmetically operates the tilt angle based on the output voltages (output signals) of the detection units 8.

In this embodiment, first, second and third accelerations sensors 2, 3 and 4, which are electrostatic capacitance-type acceleration sensors, are used as the detection units 8. As described above, in the tilt sensor unit 1 according to this embodiment, three (plural) detection units (first, second and third acceleration sensors 2, 3 and 4) 8 are arranged.

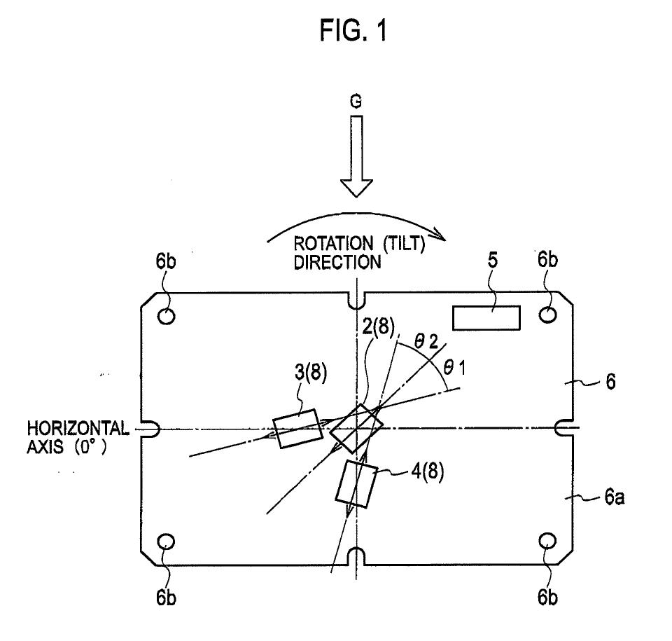

Moreover, in this embodiment, as shown in FIG. 1, the first, second and third acceleration sensors 2, 3 and 4 and the microcomputer 5 are mounted on a mounting surface (front surface) 6a of a sensor mounting board (one board) 6. This sensor mounting board 6 has a substantially rectangular shape, and insertion holes 6b are formed on four corners of the sensor mounting board 6.

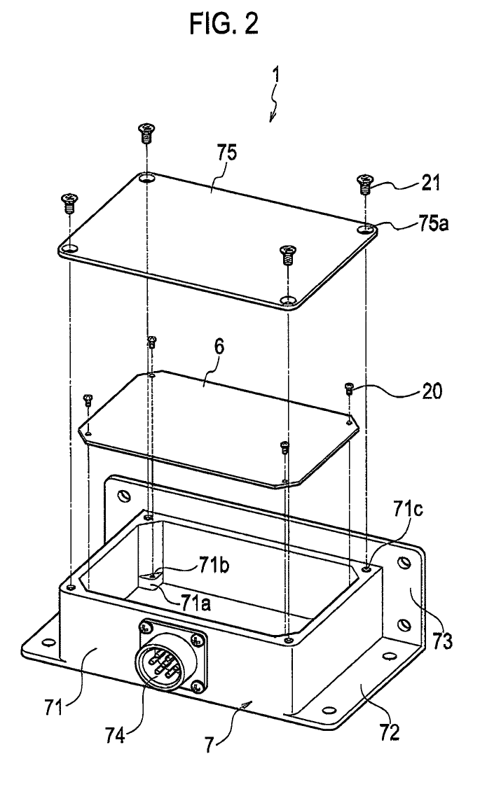

Then, as shown in FIG. 2, the sensor mounting board 6 is built in a casing 7.

In the casing 7, a rectangular parallelepiped housing unit 71, which is open upward and builds the sensor mounting board 6 therein, is provided, and on four corners in a housing space of the housing unit 71, attachment bases 71a, which mount the sensor mounting board 6 thereon, are formed. Moreover, in the mounting bases 71a, screw holes 71b are formed. Then, the sensor mounting board 6 is mounted on the attachment bases 71a so that the insertion holes 6b can communicate with the screw holes 71b, and screws 20 are inserted into the insertion holes 6b and the screw holes 71b, whereby the sensor mounting board 6 is attached onto the attachment bases 71a.

Moreover, the casing 7 includes a cover 75 in which insertion holes 75a are formed on four corners. Then, the cover 75 is mounted on the housing unit 71 so that the insertion holes 75a and screw holes 71c formed on four corners of an upper portion of the housing unit 71 can communicate with each other, and screws 21 are inserted into the insertion holes 75a and the screw holes 71c, whereby the housing space of the housing unit 71 is covered.

Furthermore, from both sides of a lower surface of the housing unit 71, first flange portions 72 are protruded, and from both sides of a back surface of the housing unit 71, second flange portions 73 are protruded. Then, the first flange portions 72 and the second flange portions 73 are fixed to a sensing target member (not shown) of which tilt angle is measured, whereby the tilt sensor unit 1 is attached to the sensing target member.

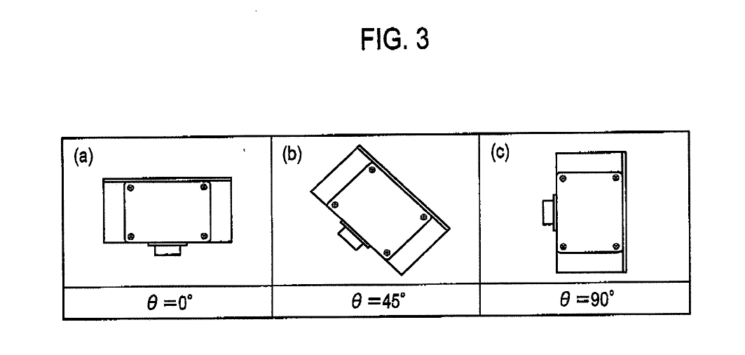

At this time, the tilt sensor unit 1 is mounted so that, in a reference state (refer to FIG. 3(a)) of the sensing target member, the first flange portions 72 can become vertical, and the second flange portions 73 can become horizontal. Moreover, on a front surface of the casing 7, a connector 74 is provided, and tilt angle information, which is arithmetically operated by the microcomputer 5, can be taken outside through the connector 74.

Note that the tilt sensor unit 1 can be mounted on a variety of sensing target members such as a photovoltaic power generation panel moved following the motion of the sun.

Here, in this embodiment, the first, second and third acceleration sensors (plurality of detection units) 2, 3 and 4 are arranged on a center portion of the mounting surface 6a of the sensor mounting board 6 or on a centerline (line, which passes through a center of the mounting surface 6a of the sensor mounting board 6, and is substantially parallel to sides of the sensor mounting board 6).

The center portion of the mounting surface 6a of the sensor mounting board 6 or a portion (band-like region including the centerline) on the centerline thereof is a region in which a change of the tilt angle of the sensor mounting board 6 is small when a temperature is changed.

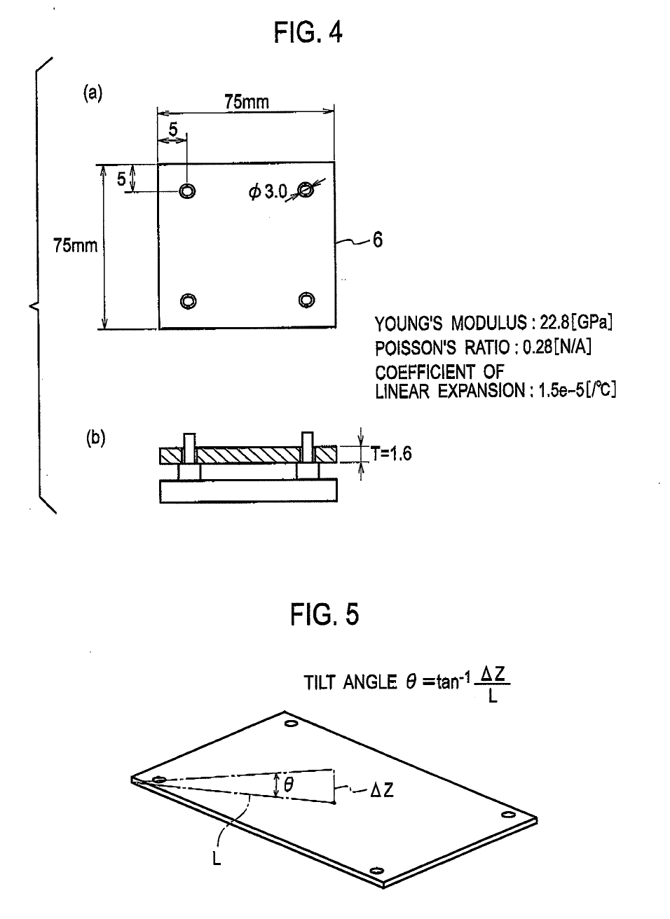

A description is made below of analysis results of a warp of the board by the temperature change based on FIG. 4(a) to FIG. 9.

This time, experiments were conducted by using a glass epoxy-made square board in which a thickness is 1.6 mm and a side length is 75 mm as shown in FIG. 4(a). Note that, in the board used this time, a Young's modulus is 22.8 GPa, a Poisson's ratio is 0.28 N/A, and a coefficient of linear expansion is 1.5×10⁻⁵/° C.

First, at positions individually separated by 5 mm from two sides of the board, which intersect each other, four through holes with a diameter of 3 mm were formed, and pins provided on a fixing base were inserted through the four through holes, whereby the board was fixed by four points to the fixing base. Then, the temperature was changed from 25° C. to 85° C. in such a state where the board was fixed by four points. When the temperature is changed from 25° C. to 85° C. as described above, the respective regions of the board are tilted. Accordingly, changes of the tilt angles on the respective regions of the front surface of the board when the temperature was changed were measured, and a region where the tilt angle of the board was small when the temperature was changed (that is, a region where a change of the tilt of the board was small when the temperature was changed) was obtained.

As shown in FIG. 5, the tilt angle θ of the board when the temperature was changed from 25° C. to 85° C. can be obtained from the following Expression (1):

θ=tan⁻¹ΔZ/L (1)

Here, reference symbol ΔZ denotes a difference between a height of a measurement point on the board surface when the temperature was 85° C. and a height of a measurement point on the board surface when the temperature was 25° C. (that is, a variation of the measurement point in a height direction when the temperature was changed), and reference symbol L denotes a distance from a reference point to the measurement point when the temperature was 25° C.

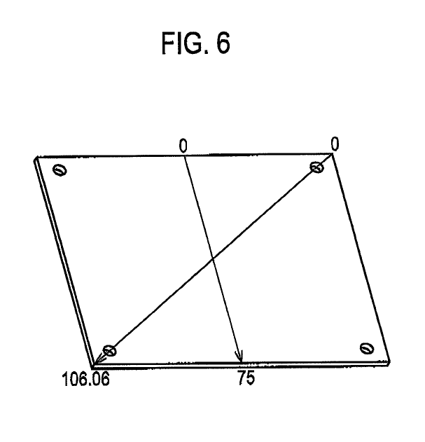

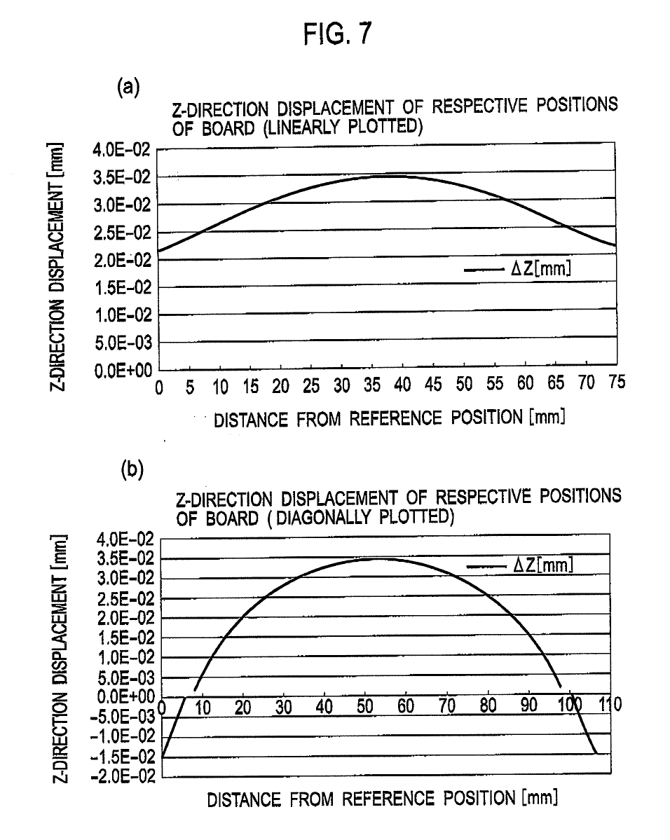

Then, as shown in FIG. 6, a midpoint of one arbitrary side on the board surface was defined as the reference point, and a point on the centerline that passes through the reference point and the center was defined as the measurement point, whereby ΔZ at each of the measurement points was obtained. ΔZ at each of the measurement points is as shown in FIG. 7(a).

Moreover, one arbitrary vertex on the board surface was defined as the reference point, and a point on a diagonal line that passes through the reference point was defined as the measurement point, whereby ΔZ at each of the measurement points was obtained. ΔZ at each of the measurement points is as shown in FIG. 7(b).

Here, when ΔZ at the points on the center line and ΔZ at the points on the diagonal line are compared with each other, it is understood from FIG. 7 that variations of displacement of ΔZ are larger (a curvature of the graph is larger) at the points on the diagonal line than at the points on the centerline.

Then, the respective graphs in FIGS. 7(a) and 7(b) represent cross-sectional shapes of the board surface when the temperature is 85° C. Hence, it is understood that the change of the tilt angle by the temperature change is smaller in the band-like region on the centerline than in a band-like region on the diagonal line.

Note that, when the temperature is 25° C., the board surface is flat, and the respective cross-sectional shapes of the board surface become horizontal lines.

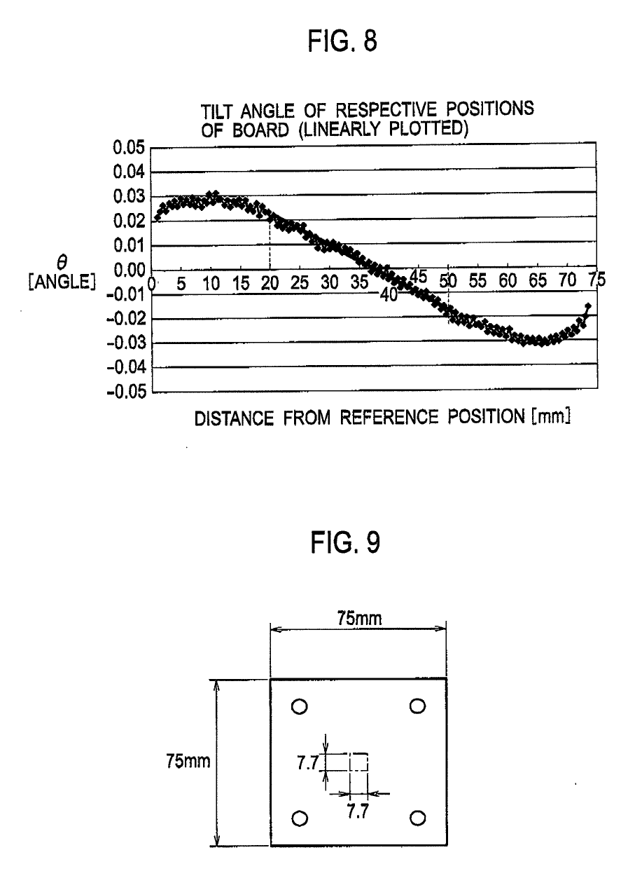

Next, the tilt angles θ at the respective measurement points on the centerline were obtained by Expression (1), and a region where the change of the tilt angle is small in the band-like region on the centerline was obtained. The tilt angles θ at the respective points on the centerline are as shown in FIG. 8.

From FIG. 8, it is understood that a relationship between the distance from the reference position (point) and the tilt angle is a substantially proportional relationship in a range where the distance from the reference position is 20 mm to 50 mm.

Accordingly, the relationship between the distance from the reference position and the tilt angle in the range where the distance from the reference position is 20 mm to 50 mm was linearly approximated by the least-squares method, and a range where the tilt angle becomes ±0.01° (that is, a region less affected by the temperature change of the tilt angle) was obtained.

When the distance from the reference position is X, and the tilt angle is Y, an approximation straight line by the least-squares method becomes:

Y=0.0013×X+0.04875 (2)

Hence, from Expression (2), the range where the tilt angle becomes ±0.01° becomes: 29.8<X<45.2. Here, since the length of one side of the board is 75 mm, the range where the change of the tilt angle becomes ±0.01° when the temperature is changed becomes the center position (37.5 mm) of the board ±7.7 mm.

Specifically, as shown in FIG. 9, a square region (center portion of the board), in which the board center is defined as a center, and a length of one side is approximately 10% of the length of one side of the board becomes a region in which the change of the tilt angle by the temperature change is the smallest.

From the above-described experimental results, in this embodiment, the first, second and third acceleration sensors (plurality of detection units) 2, 3 and 4 were arranged on the center portion or centerline of the mounting surface 6a of the sensor mounting board 6.

Specifically, the first acceleration sensor 2 was arranged on the center portion of the mounting surface 6a of the sensor mounting board 6. Then, the second acceleration sensor 3 was arranged on a horizontal centerline of the mounting surface 6a of the sensor mounting board 6, and the third acceleration sensor 4 was arranged on a vertical centerline of the mounting surface 6a of the sensor mounting board 6.

Moreover, in this embodiment, 1-axis acceleration sensors, in which detection axes 2A, 3A and 4A are in single directions, are used as the first, second and third acceleration sensors 2, 3 and 4, respectively.

As these first, second and third acceleration sensors 2, 3 and 4, acceleration sensors can be used, which are formed on semiconductor substrates, and have electrostatic capacitance-type sensing units composed of comb teeth-like fixed and movable electrodes opposite to each other at an interval. Each of these acceleration sensors is configured to detect a change of an electrostatic capacitance value between the movable electrode and the fixed electrode, which is caused by positional displacement of the movable electrode, and to sense acceleration applied to the acceleration sensor concerned based on the detected change of the electrostatic capacitance value. Note that it is preferable to use acceleration sensors of the same type with the same sensitivity as the first, second and third acceleration sensors 2, 3 and 4.

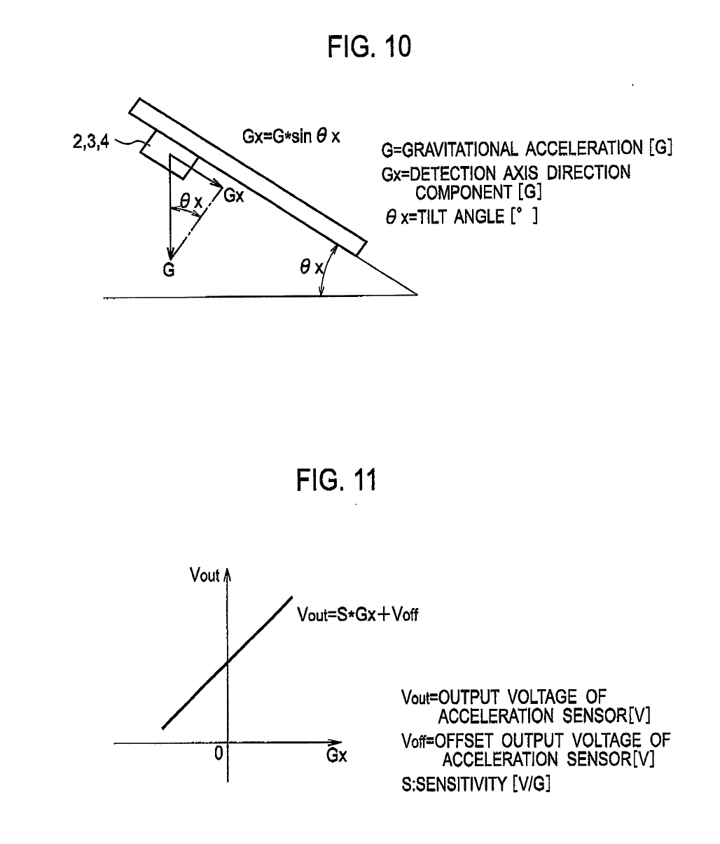

Here, a description is made of a sensing principle of each of the acceleration sensors based on FIG. 10 to FIG. 15.

First, as shown in FIG. 10, when the acceleration sensor arranged so that the detection axis thereof can be horizontal is tilted by θx with respect to the horizontal plane, the movable electrode of the acceleration sensor is brought into an equivalent state to that of being applied with acceleration of a detection axis direction component Gx of the gravitational acceleration G.

Specifically, acceleration represented by the following Expression (3) is applied to the movable electrode of the acceleration sensor:

Gx=G×sin θ (3)

Here, a relationship between the detection axis direction component Gx and an output voltage Vout of the acceleration sensor becomes as shown in FIG. 11, and is represented by the following Expression (4):

Vout=S×Gx+Voff (4)

Specifically, the output voltage Vout of the acceleration sensor is proportional to the detection axis direction component Gx. Note that reference symbol S denotes the sensitivity of the acceleration sensor, and reference symbol Voff denotes an offset output voltage (output voltage value when the sensor is arranged so that the detection axis can be horizontal) of the acceleration sensor.

Then, when Expression (3) is assigned to Expression (4) mentioned above, a relationship between the tilt angle θx and the output voltage Vout of the acceleration sensor can be derived.

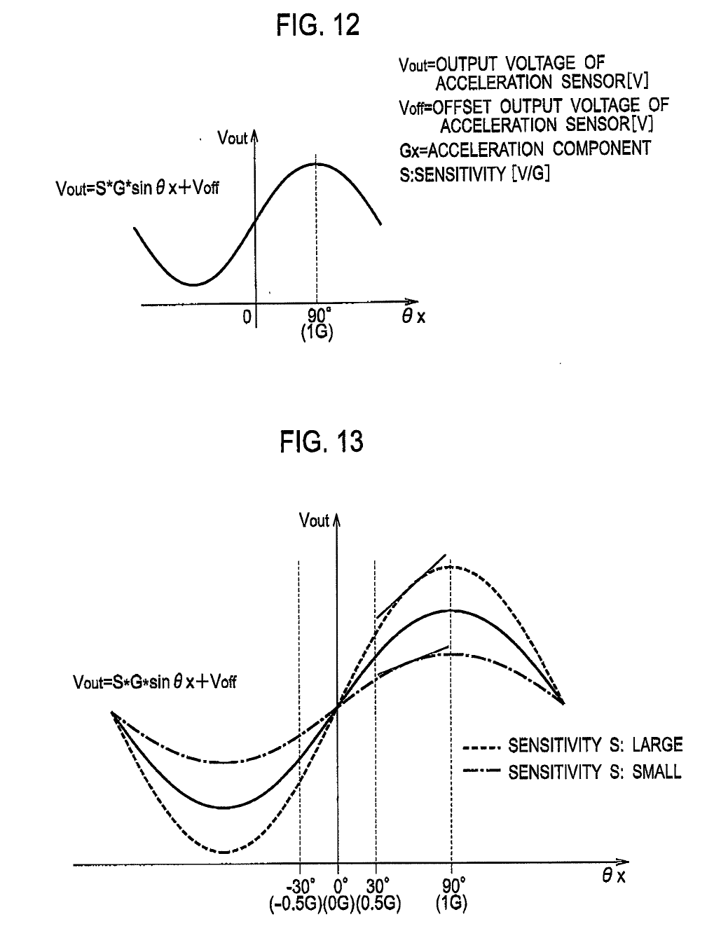

Specifically, as shown in FIG. 12, the relationship between the tilt angle θx and the output voltage Vout of the acceleration sensor is represented by the following Expression (5):

Vout=S×G×sin θ+Voff (5)

The above-described relationship is drawn as a sine curve.

As described above, the relationship between the tilt angle θx and the output voltage Vout of the acceleration sensor is drawn as the sine curve, and accordingly, a variation of an output voltage value with respect to the change of the tilt angle of the acceleration sensor differs depending on a value of the tilt angle before being changed.

Specifically, as shown in FIG. 13, in the vicinity where the tilt angle of the acceleration sensor is 0°, a tilt of a tangential line is increased, and as approaching 90°, the tilt of the tangential line is reduced. When the tilt of the tangential line is small as described above, a variation of the output value by an angle change is reduced, and it becomes difficult to sense a small change of the tilt angle.

Moreover, even in the case of the same angle, the tilt of the tangential line differs depending on a magnitude of the sensitivity of the acceleration sensor. Specifically, as shown in FIG. 13, the tilt of the tangential line is increased in an acceleration sensor having large (high) sensitivity than in an acceleration sensor having small (low) sensitivity. As described above, the variation of the output voltage value by the angle change is increased in the acceleration sensor having large sensitivity. Accordingly, when the acceleration sensor having large sensitivity is used, the change of the tilt angle can be sensed with higher precision.

Here, in this embodiment, the first, second and third acceleration sensors 2, 3 and 4 (at least two detection units among the plurality of detection units) were mounted on the sensor mounting board 6 so that the detection axes 2A, 3A and 4A thereof can be directed in directions different from one another.

Specifically, on the sensor mounting board 6 arranged so that the mounting surface 6a can be a vertical plane, the first acceleration sensor (first detection unit) 2 was mounted in a state where the detection axis 2A was tilted by 45° with respect to the horizontal direction. Then, as shown in FIG. 1, the second acceleration sensor (second detection unit) 3 was mounted on the sensor mounting board 6 so that the detection axis 3A can be in a state of being substantially parallel to the mounting surface (corresponding to a plane including the detection axis of the first detection unit) 6a, and being rotated by a first angle θ1 in one direction (clockwise direction in FIG. 1) with respect to the detection axis 2A of the first acceleration sensor (first detection unit) 2. Moreover, as shown in FIG. 1, the third acceleration sensor (third detection unit) 4 was mounted on the sensor mounting board 6 so that the detection axis 4A can be in a state of being substantially parallel to the mounting surface (corresponding to the plane including the detection axis of the first detection unit) 6a, and being rotated by a second angle θ2 in a reverse direction (counterclockwise direction in FIG. 1) with respect to the detection axis 2A of the first acceleration sensor (first detection unit) 2.

Note that, in FIG. 1, the one is illustrated, in which the first acceleration sensor 2 is arranged on the center portion of the mounting surface 6a, and the second and third acceleration sensors 3 and 4 are arranged on the horizontal and vertical centerlines thereof; however, attachment positions of the acceleration sensors are not limited to those shown in FIG. 1. Specifically, the second acceleration sensor 3 just needs to be in a state where the detection axis 3A is rotated by the first angle θ1 with respect to the detection axis 2A, and the third acceleration sensor 4 just needs to be in a state where the detection axis 4A is rotated by the second angle θ2 with respect to the detection axis 2A.

For example, in FIG. 1, the first, second and third acceleration sensors 2, 3 and 4 may be arranged so that such arrangement positions thereof can be changed with one another. Specifically, the second acceleration sensor 3 or the third acceleration sensor 4 may be arranged on the center portion of the mounting surface 6a, or the first acceleration sensor 2 or the third acceleration sensor 4 maybe arranged on the horizontal centerline.

Moreover, in this embodiment, the first angle θ1 and the second angle θ2 are individually set at 30 degrees. Specifically, as shown in FIG. 1, the second acceleration sensor (second detection unit) 3 is mounted on the sensor mounting board 6, which is arranged so that the mounting surface 6a can be the vertical plane, in a state where the detection axis 3A is tilted by 15° with respect to the horizontal direction. Moreover, as shown in FIG. 1, the third acceleration sensor (third detection unit) 4 is mounted on the sensor mounting board 6, which is arranged so that the mounting surface 6a can be the vertical plane, in a state where the detection axis 4A is tilted by 75° with respect to the horizontal direction.

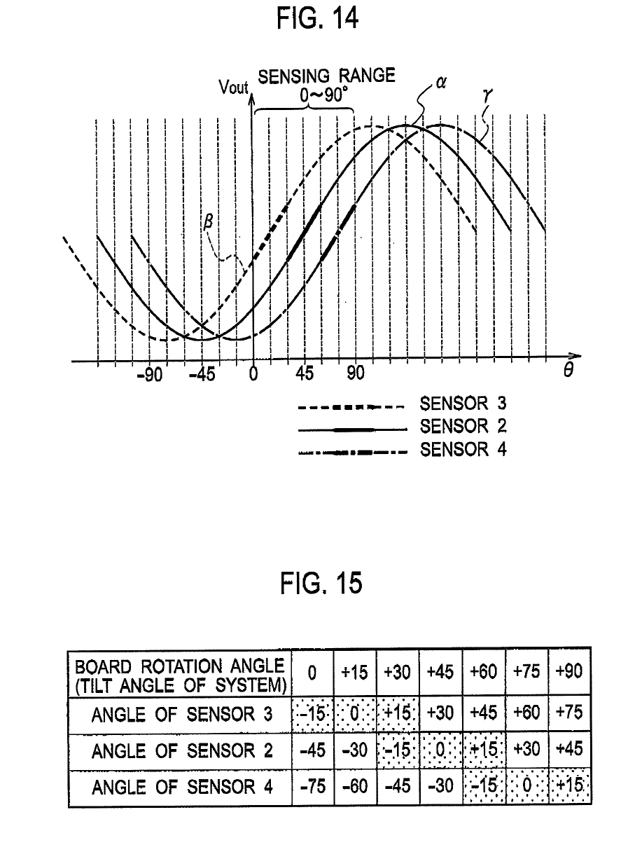

At this time, as shown in FIG. 14, output characteristics of the first, second and third acceleration sensors 2, 3 and 4 become: a first characteristic line a (solid line in FIG. 14) in the first acceleration sensor 2; a second characteristic line β (broken line in FIG. 14) in the second acceleration sensor 3; and a third characteristic line γ (dash-dot line in FIG. 14) in the third acceleration sensor 4.

Incidentally, in this embodiment, as mentioned above, the acceleration sensor is configured to sense, as the acceleration, the detection axis direction component Gx (G×sin θ in the case of tilting the acceleration sensor by θ with respect to the horizon) of the gravitational acceleration G. Therefore, as shown in FIG. 14, the first characteristic line α, the second characteristic line β and the third characteristic line γ are drawn as sine curves having phase differences of 30 degrees thereamong.

The microcomputer 5 is configured to take in voltages outputted individually from the first, second and third acceleration sensors 2, 3 and 4, and to arithmetically operate the acceleration to the detection axes 2A, 3A and 4A of the respective acceleration sensors 2, 3 and 4 based on the output voltages (output signals) concerned. As mentioned above, this acceleration is changed in response to the tilt angles of the detection axes with respect to the horizon, and the tilt angle is calculated by using the change of the acceleration. Note that, in this embodiment, those which output analog signals corresponding to the acceleration are used as the first, second and third acceleration sensors 2, 3 and 4.

Moreover, in this embodiment, the tilt angle of the tilt sensor unit 1, which is obtained when the tilt sensor unit 1 is rotated about an axis perpendicular to the mounting surface 6a in a state where the sensor mounting board 6 is arranged vertically (in the direction of the gravitational acceleration G), is adapted to be sensed.

At this time, the first, second and third acceleration sensors (detection units arranged so that the detection axes can be directed in the directions different from one another) 2, 3 and 4 are arranged so that, even in the case where any of the detection axes 2A, 3A and 4A is made horizontal among the detection axes 2A, 3A and 4A of the first, second and third acceleration sensors 2, 3 and 4, the other detection axes of the detection units cannot be horizontal in the state where the sensor mounting board 6 is arranged vertically (that is, in a state where the tilt sensor unit 1 is enabled to detect the tilt angle).

Specifically, in this embodiment, the first, second and third acceleration sensors 2, 3 and 4 are arranged so that, among the detection axes 2A, 3A and 4A, in the case where the detection axis 2A is made horizontal, the other detection axes 3A and 4A cannot become horizontal, in the case where the detection axis 3A is made horizontal, the other detection axes 2A and 4A cannot become horizontal, and in the case where the detection axis 4A is made horizontal, the other detection axes 2A and 3A cannot become horizontal.

Here, in this embodiment, the microcomputer (signal processing unit) 5 is configured to select an acceleration sensor (detection unit) in which a detection axis is the nearest the horizon from among the first, second and third acceleration sensors (detection units arranged so that the detection axes can be directed in the directions different from one another) 2, 3 and 4, and to arithmetically operate the tilt angle based on the output signal of the selected acceleration sensor (detection unit).

Specifically, the tilt angle is adapted to be arithmetically operated based on a data output from a sensor in which a value of the output voltage Vout is the nearest the offset output voltage Voff among the output voltages Vout indicated by the first, second and third acceleration sensors 2, 3 and 4.

Here, in this embodiment, the first angle θ1 and the second angle θ2 are individually set at 30 degrees. Hence, in the case where the sensor mounting board 6, that is, the tilt sensor unit 1 is rotated while defining the horizontal direction as 0 degree and the clockwise direction as + (refer to FIGS. 3(a) to 3(c)), the respective acceleration sensors 2, 3 and 4 are selected (refer to FIG. 15) when a rotation angle (tilt angle) of the tilt sensor unit 1 is in the following ranges.

First, in a range where the rotation angle (tilt angle) of the tilt sensor unit 1 is from 0 degree to +30 degrees, the second sensor 3 is selected. At this time, the tilt of the tilt axis of the second acceleration sensor 3 is in a range from −15 degrees to +15 degrees with respect to the horizon.

Moreover, in a range where the rotation angle (tilt angle) of the tilt sensor unit 1 is from +30 degree to +60 degrees, the first sensor 2 is selected. At this time, the tilt of the tilt axis of the first acceleration sensor 2 is in the range from −15 degrees to +15 degrees with respect to the horizon.

Furthermore, in a range where the rotation angle (tilt angle) of the tilt sensor unit 1 is from +60 degree to +90 degrees, the third sensor 4 is selected. At this time, the tilt of the tilt axis of the third acceleration sensor 4 is in the range from −15 degrees to +15 degrees with respect to the horizon.

As described above, the first angle θ1 and the second angle θ2 are individually set at 30 degrees. In such a way, such acceleration sensors can become usable, which are in the range from −15 degrees to +15 degrees with respect to the horizon even if the tilt angle of the tilt sensor unit 1 is any angle from 0 degree to +90 degrees in the case where the tilt sensor unit 1 is rotated (tilted) from 0 degree to +90 degrees. The characteristic lines α, β and γ draw the sine curves, and as shown in FIG. 14, become substantially straight lines (largely tilted lines among the respective sensor output characteristics) in the range from −15 degrees to +15 degrees with respect to the horizon (bold line portions of the characteristic lines α, β and γ in FIG. 14). Specifically, in this embodiment, in the first, second and third acceleration sensors 2, 3 and 4, only the ranges where the tilt angle can be accurately detected are adapted to be used.

Specifically, in this embodiment, in the event where the tilt sensor unit 1 is rotated from 0 degree to +90 degrees in the + direction (clockwise direction in FIG. 1) as the one direction, the microcomputer (signal processing unit) 5 is configured to select the acceleration sensors for the tilt angle detection in order from the second acceleration sensor (second detection unit) 3 through the first acceleration sensor (first detection unit) 2 to the third acceleration sensor (third detection unit) 4.

Meanwhile, in the event where the tilt sensor unit 1 is rotated from +90 degree to 0 degree in the − direction (counterclockwise direction in FIG. 1) as the reverse direction, the microcomputer (signal processing unit) 5 is configured to select the acceleration sensors for the tilt angle detection in order from the third acceleration sensor (third detection unit) 4 through the first acceleration sensor (first detection unit) 2 to the second acceleration sensor (second detection unit) 3.

Then, the tilt angle is arithmetically operated based on the output voltage (output signal) Vout of the selected acceleration sensor.

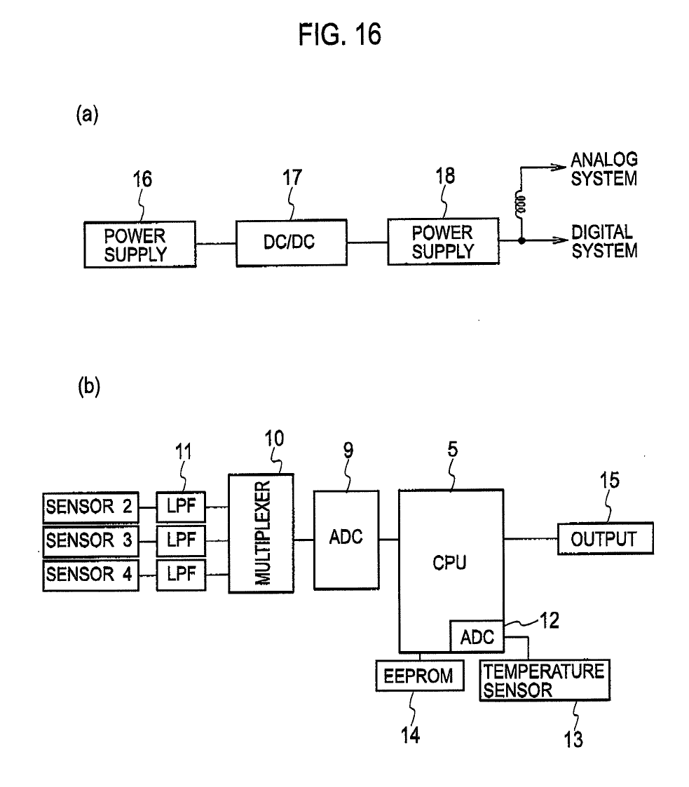

Incidentally, the microcomputer (signal processing unit) 5 and first, second and third acceleration sensors 2, 3 and 4 of the tilt sensor unit 1 according to this embodiment are those operated by receiving supply of power supply from an external power supply 16 (refer to FIGS. 16(a) and 16(b)).

Here, a description is made of a power feed system and sensor system of the tilt sensor unit 1 according to this embodiment based on FIGS. 16(a) and 16(b).

First a description is made of the power feed system based on FIG. 16(a).

In this embodiment, as shown in FIG. 16(a), the power supply (for example, power supply of 24V) supplied from the external power supply 16 is adapted to be converted, for example, into power supply of 5V by a DC/DC converter and a regulator 18. Then, the power supply converted into 5V is adapted to be supplied to analog components such as the first, second and third acceleration sensors 2, 3 and 4 and digital components such as the microcomputer (signal processing unit) 5.

Next, a description is made of the sensor system based on FIG. 16(b).

In this embodiment, the microcomputer (signal processing unit) 5 has a CPU 5a. The output voltages (output signals) Vout of the first, second and third acceleration sensors 2, 3 and 4 are transmitted to the CPU 5a, and the arithmetic operation of the tilt angle is performed in the CPU 5a.

Specifically, as shown in FIG. 16(b), the first, second and third acceleration sensors 2, 3 and 4 are connected to a multiplexer 10 through low-pass filters (LPFs) 11, and the multiplexer 10 is connected to the CPU 5a through an AD converter (ADC) 9.

With such a configuration, the output voltages (output signals) Vout of the first, second and third acceleration sensors 2, 3 and 4 are transmitted to the multiplexer 10 in a state where noise is removed individually therefrom by the low-pass filters (LPFs) 11.

Then, only one output voltage (output signal) Vout (the output voltage of the acceleration sensor in which the detection axis is the nearest the horizon) among the output voltages (output signals) Vout of the first, second and third acceleration sensors 2, 3 and 4 is transmitted to the CPU 5a.

At this time, analog data transmitted from the multiplexer 10 is converted into digital data by the AC converter (ADC) 9, and is transmitted as the digital data to the CPU 5a.

Moreover, a temperature sensor 13 is connected to the CPU 5a, and an output value of an analog signal obtained from the temperature sensor 13 is also adapted to be converted into digital data by the AD converter (ADC) 12, and to be transmitted as the digital data to the CPU 5a.

Moreover, an EEPROM 14 is connected to the CPU 5a. In this EEPROM 14, a table is stored, in which such output values of the temperature sensor 13 and correction data for use in correcting the output values of the acceleration sensors are allowed to correspond to each other. In such a way, the offset output voltage Voff and sensitivity S of each of the acceleration sensors are adapted to be correctable in response to temperature characteristics thereof.

Then, an arithmetic operation of the tilt angle, which is subjected to the temperature correction in the CPU 5a, is adapted to be performed, and data thus obtained is adapted to be outputted from an output 15.

As described above, in this embodiment, the first, second and third acceleration sensors 2, 3 and 4 (at least two detection units among the plurality of detection units) are mounted on the sensor mounting board 6 so that the detection axes 2A, 3A and 4A thereof can be directed in the directions different from one another. Moreover, the first, second and third acceleration sensors 2, 3 and 4 (detection units arranged so that the detection axes can be directed in the directions different from one another) are arranged so that, even in the case where any of the detection axes 2A, 3A and 4A is made horizontal among the detection axes 2A, 3A and 4A of the first, second and third acceleration sensors 2, 3 and 4, the other detection axes of the detection units cannot be horizontal in the state where the sensor mounting board 6 is arranged vertically (that is, in the state where the tilt sensor unit 1 is enabled to detect the tilt angle). Specifically, the range of the accurately detectable tilt angle of the tilt sensor unit 1 is made to differ for each of the detection units.

Moreover, the microcomputer (signal processing unit) 5 is adapted to select the acceleration sensor (detection unit) in which the detection axis is the nearest the horizon among the first, second and third acceleration sensors (detection units arranged so that the detection axes can be directed in the directions different from one another), and to arithmetically operate the tilt angle based on the output signal of the selected acceleration sensor (detection unit). As a result, it becomes possible for the microcomputer (signal processing unit) 5 to select the detection unit, which can detect the tilt angle more accurately, from among the detection units among which the range of the accurately detectable tilt angle of the tilt sensor unit 1 differs, and to arithmetically operate the tilt angle based on the output signal of the detection unit concerned.

As described above, in accordance with this embodiment, it becomes possible to accurately detect the tilt angle of the tilt sensor unit 1 over a wider range.

Moreover, in this embodiment, the first angle θ1 and the second angle θ2 are individually set at 30 degrees. Therefore, even if the tilt angle of the tilt sensor unit 1 is any angle from 0 degree to +90 degrees, the acceleration sensor in the range from −15 degrees to +15 degrees with respect to the horizon becomes usable among the first, second and third acceleration sensors 2, 3 and 4. Specifically, the tilt angle of the tilt sensor unit 1 can be accurately detected over 90 degrees. Note that, in the case of setting the first and second angles θ1 and θ2 at the vicinity of 30 degrees, it becomes possible to accurately detect the tilt angle over approximately 90 degrees.

Moreover, according to this embodiment, the first, second and third acceleration sensors 2, 3 and 4 are individually arranged on the mounting surface (front surface) 6a of the sensor mounting board (one board) 6. Accordingly, in comparison with the case where the individual acceleration sensors are attached to separate boards, the attachment positions of the individual acceleration sensors can be suppressed from being shifted from one another. Specifically, the first, second and third acceleration sensors 2, 3 and 4 are individually arranged on the mounting surface (front surface) 6a of the sensor mounting board (one board) 6, whereby the tilt angle of the tilt sensor unit 1 can be detected more accurately.

Furthermore, the first, second and third acceleration sensors (plurality of detection units) 2, 3 and 4 are arranged on the center portion or centerline of the mounting surface 6a of the sensor mounting board 6. Specifically, the first, second and third acceleration sensors 2, 3 and 4 are attached to places where the change of the tilt angle by the temperature change is small, and accordingly, a sensing error caused by the temperature change can be suppressed to the minimum, and the decrease of the accuracy can be suppressed.

Moreover, in this embodiment, the acceleration sensor near the horizon is selected, and the tilt angle is arithmetically operated based on the output value of the acceleration sensor concerned. Therefore, even if the gravitational acceleration is changed in such a case where an installation place of the tilt sensor unit 1 is changed, an error caused by such a change of the gravitational acceleration can be reduced. Specifically, in accordance with this embodiment, the tilt sensor unit 1, which is less likely to be affected by geographical conditions, can be obtained.

Furthermore, in accordance with this embodiment, the 1-axis sensors are individually used as the first, second and third acceleration sensors 2, 3 and 4. Note that, though the present invention can be embodied even in the case of using 2-axis sensors and 3-axis sensors, the sensitivity of each of the acceleration sensors can be enhanced in the case of using the 1-axis sensors in comparison with the case of using the 2-axis sensors and the 3-axis sensors. As a result, the tilt angle of the tilt sensor unit 1 can be detected more accurately.

### Second Embodiment

A tilt sensor unit 1A according to this embodiment basically has a substantially similar configuration to that of the above-described first embodiment.

Specifically, the tilt sensor unit 1A includes: detection units 8 which output output voltages (output signals) corresponding to the tilt angle; and a microcomputer (signal processing unit) 5 that arithmetically operates the tilt angle based on the output voltages (output signals) of the detection unit 8 concerned.

Then, first, second and third acceleration sensors 2, 3 and 4 as electrostatic capacitance-type acceleration sensors 2, 3 and 4 are used as the detection units 8.

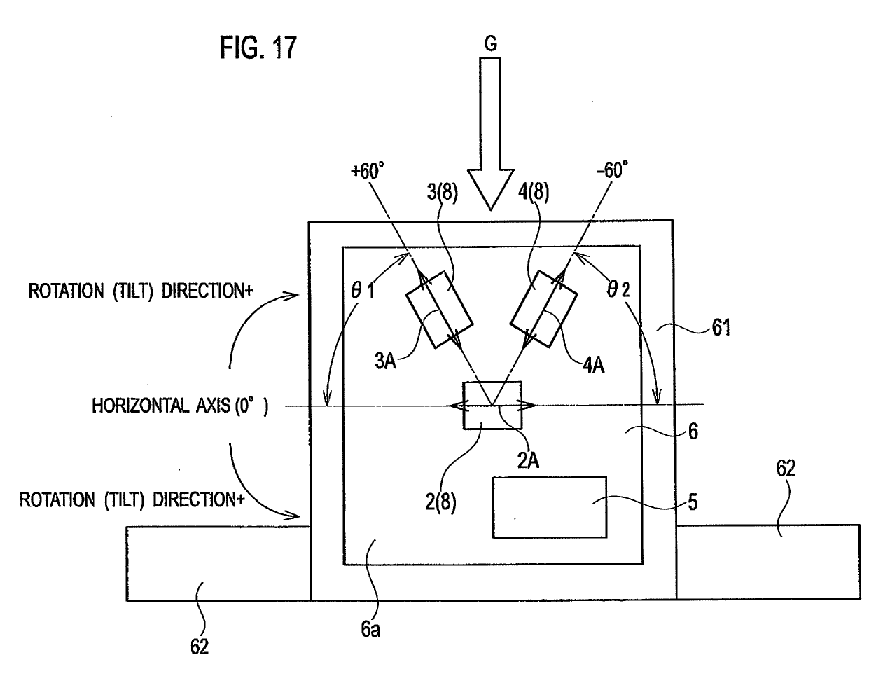

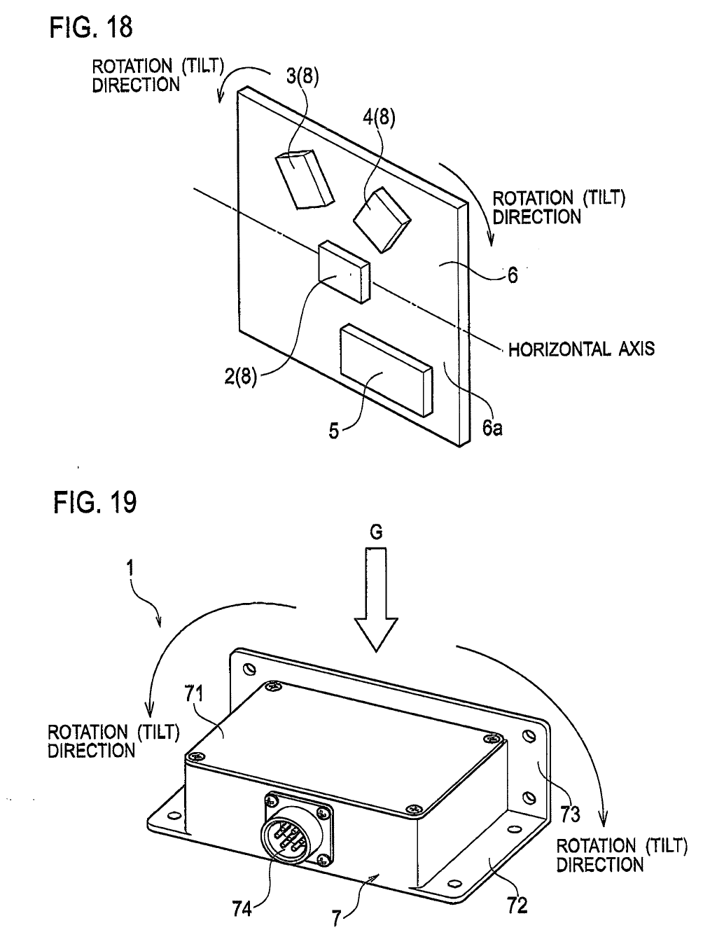

Moreover, as shown in FIG. 17 and FIG. 18, the first, second and third acceleration sensors 2, 3 and 4 and the microcomputer 5 are mounted on a mounting surface (front surface) 6a of a sensor mounting board (one board) 6. As described above, also on the tilt sensor unit 1A according to this embodiment, three (plural) detection units (first, second and third acceleration sensors 2, 3 and 4) 8 are arranged.

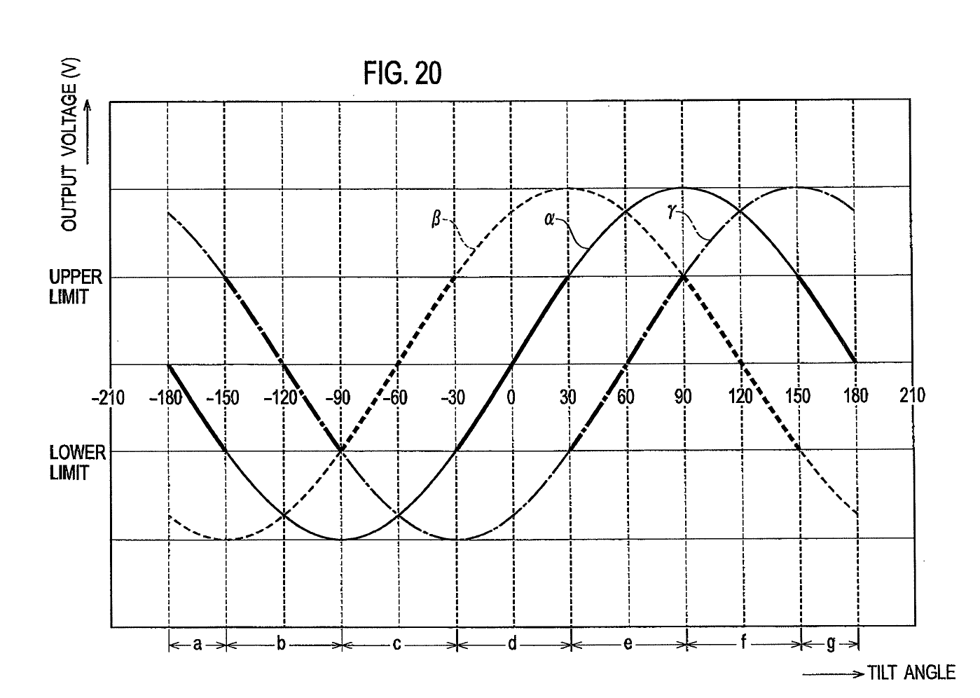

Then, as shown in FIG. 19, the sensor mounting board 6 is built in a casing 7.

Moreover, also in this embodiment, 1-axis acceleration sensors, in which detection axes 2A, 3A and 4A are in single directions, are used as the first, second and third acceleration sensors 2, 3 and 4, respectively.

As these first, second and third acceleration sensors 2, 3 and 4, acceleration sensors can be used, which are formed on semiconductor substrates, and have electrostatic capacitance-type sensing units composed of comb teeth-like fixed and movable electrodes opposite to each other at an interval. Each of these acceleration sensors is configured to detect a change of an electrostatic capacitance value between the movable electrode and the fixed electrode, which is caused by positional displacement of the movable electrode, and to sense acceleration applied to the acceleration sensor concerned based on the detected change of the electrostatic capacitance value. Note that it is preferable to use acceleration sensors of the same type with the same sensitivity as the first, second and third acceleration sensors 2, 3 and 4.

Moreover, in this embodiment, the first, second and third acceleration sensors 2, 3 and 4 (at least two detection units among the plurality of detection units) are mounted on the sensor mounting board 6 so that the detection axes 2A, 3A and 4A thereof can be directed in directions different from one another.

Specifically, as shown in FIG. 17, the first acceleration sensor (first detection unit) 2 is mounted on the sensor mounting board 6, which is arranged so that the mounting surface 6a can be a vertical plane, so that the detection axis 2A can be directed in a horizontal direction (predetermined direction). Then, as shown in FIG. 17, the second acceleration sensor (second detection unit) 3 is mounted on the sensor mounting board 6 so that the detection axis 3A can be in a state of being substantially parallel to the mounting surface (corresponding to a plane including the detection axis of the first detection unit) 6a, and being rotated by a first angle θ1 in one direction (clockwise direction in FIG. 17) with respect to the detection axis 2A of the first acceleration sensor (first detection unit) 2. Moreover, as shown in FIG. 17, the third acceleration sensor (third detection unit) 4 is mounted on the sensor mounting board 6 so that the detection axis 4A can be in a state of being substantially parallel to the mounting surface (corresponding to the plane including the detection axis of the first detection unit) 6a, and being rotated by a second angle θ2 in a reverse direction (counterclockwise direction in FIG. 17) with respect to the detection axis 2A of the first acceleration sensor (first detection unit) 2.

Note that, in FIG. 17, the one is illustrated, in which the second acceleration sensor 3 is arranged left upward of the first acceleration sensor 1, and the third acceleration sensor 4 is arranged right upward of the first acceleration sensor 2; however, attachment positions of the acceleration sensors are not limited to those shown in FIG. 17. The second acceleration sensor 3 just needs to be in a state where the detection axis 3A is rotated by the first angle θ1 with respect to the detection axis 2A, and the third acceleration sensor 4 just needs to be in a state where the detection axis 4A is rotated by the second angle θ2 with respect to the detection axis 2A.

For example, in FIG. 17, the second acceleration sensor 3 may be arranged right upward of the first acceleration sensor 2, the third acceleration sensor 4 may be arranged left upward of the first acceleration sensor 2, and the first, second and third acceleration sensors 2, 3 and 4 may be attached so that the detection axes 2A, 3A and 4A can form the respective sides of a triangle. In such a way, a region to which the first, second and third acceleration sensors 2, 3 and 4 are attached can be reduced, and it becomes possible to achieve further miniaturization of the tilt sensor unit 1.

Here, in this embodiment, the first angle θ1 and the second angle θ2 are individually set at 60 degrees. At this time, as shown in FIG. 20, output characteristics of the first, second and third acceleration sensors 2, 3 and 4 become: a first characteristic line α (solid line in FIG. 20) in the first acceleration sensor 2; a second characteristic line β (broken line in FIG. 20) in the second acceleration sensor 3; and a third characteristic line γ (dash-dot line in FIG. 20) in the third acceleration sensor 4.

Incidentally, also in this embodiment, the acceleration sensor is configured to sense, as the acceleration, the detection axis direction component (G×sin θ in the case of tilting the acceleration sensor by θ with respect to the horizon) of the gravitational acceleration G. Therefore, as shown in FIG. 20, the first characteristic line α, the second characteristic line β and the third characteristic line γ are drawn as sine curves having phase differences of 60 degrees thereamong.

The microcomputer 5 is configured to take in voltages outputted individually from the first, second and third acceleration sensors 2, 3 and 4, and to arithmetically operate the acceleration to the detection axes 2A, 3A and 4A of the respective acceleration sensors 2, 3 and 4 based on the output voltages (output signals) concerned. As mentioned above, this acceleration is changed in response to the tilt angles of the detection axes with respect to the horizon, and the tilt angle is calculated by using the change of the acceleration.

In this embodiment, the sensor mounting board 6 is arranged vertically (in the direction of the gravitational acceleration G), and is built in and fixed to the casing 7 in this state. Note that, as shown in the above-described first embodiment, the sensor mounting board 6 may be built in the, casing 7 in the state of being horizontally arranged.

In this embodiment, as shown in FIG. 17, the sensor mounting board 6 is supported and fixed to an attachment plate 61, and the attachment plate 61 is fixed to the casing 7 while interposing therebetween attachment brackets 62 protruded on both sides of a lower end portion of the attachment plate 61.

As described above, in this embodiment, the tilt angle of the tilt sensor unit 1A, which is obtained when the tilt sensor unit 1A is rotated about an axis perpendicular to the mounting surface 6a in a state where the sensor mounting board 6 is arranged vertically (in the direction of the gravitational acceleration G), is adapted to be sensed.

At this time, the first, second and third acceleration sensors (detection units arranged so that the detection axes can be directed in the directions different from one another) 2, 3 and 4 are arranged so that, even in the case where any of the detection axes 2A, 3A and 4A is made horizontal among the detection axes 2A, 3A and 4A of the first, second and third acceleration sensors 2, 3 and 4, the other detection axes of the detection units cannot be horizontal in the state where the sensor mounting board 6 is arranged vertically (that is, in a state where the tilt sensor unit 1A is enabled to detect the tilt angle).

Specifically, in this embodiment, the first, second and third acceleration sensors 2, 3 and 4 are arranged so that, among the detection axes 2A, 3A and 4A, in the case where the detection axis 2A is made horizontal, the other detection axes 3A and 4A cannot become horizontal, in the case where the detection axis 3A is made horizontal, the other detection axes 2A and 4A cannot become horizontal, and in the case where the detection axis 4A is made horizontal, the other detection axes 2A and 3A cannot become horizontal.

In the casing 7, a rectangular parallelepiped housing unit 71, which builds the sensor mounting board 6 therein, is provided, and horizontal flange portions 72 are protruded from both sides of a lower surface of the housing unit 71 concerned. Moreover, vertical flange portions 73 are protruded from both sides of a back surface of the housing unit 71. Then, the horizontal flange portions 72 and the vertical flange portions 73 are fixed to a sensing target member (not shown) of which tilt angle is measured, whereby the tilt sensor unit 1A is attached to the sensing target member. At this time, the tilt sensor unit 1A is mounted so that, in a reference state of the sensing target member, the horizontal flange portions 72 can become horizontal, and the vertical flange portions 73 can become vertical. Moreover, on a front surface of the casing 7, a connector 74 is provided, and tilt angle information, which is arithmetically operated by the microcomputer 5, can be taken outside through the connector 74.

Note that the tilt sensor unit 1A according to this embodiment can also be mounted on a variety of sensing target members such as a photovoltaic power generation panel moved following the motion of the sun.

Here, in this embodiment, the microcomputer (signal processing unit) 5 is configured to select an acceleration sensor (detection unit), in which a detected output signal is within a predetermined range, from among the first, second and third acceleration sensors (detection units arranged so that the detection axes can be directed in the directions different from one another) 2, 3 and 4, and to arithmetically operate the tilt angle based on the output signal of the selected acceleration sensor (detection unit).

Specifically, the microcomputer 5 is allowed to memorize, as threshold values, an upper limit value and lower limit value of a preset output voltage, and the tilt angle is arithmetically operated based on an output signal of the acceleration sensor, in which the output voltage is within a range between the upper and lower limit values.

In this embodiment, the threshold values are set so that, in the case where a horizontally oriented state of the detection axis is defined as 0 degree and a clockwise direction thereof is defined as + in FIG. 17, voltages outputted when the respective sensors 2, 3 and 4 are tilted by −30 degrees with respect to the horizon can become the lower limit value, and voltages outputted when the respective sensors 2, 3 and 4 are tilted by +30 degrees with respect to the horizon can become the upper limit value. Here, the first, second and third characteristic lines α, β and γ draw the sine curves, and as shown in FIG. 20, become substantially straight lines in the range from −30 degrees to +30 degrees with respect to the horizon (bold line portions of the characteristic lines α, β and γ in FIG. 20). Then, in a range from −30 degrees to +30 degrees with respect to the horizon, a variation of the output voltage with respect to a unit angle change of each of the acceleration sensors is increased more than in a range out of the range from −30 degrees to +30 degrees with respect to the horizon. Hence, in the case where the acceleration sensor is in the range from −30 degrees to +30 degrees with respect to the horizon, the tilt can be detected more accurately in comparison with the case where the acceleration sensor is in the range out of the range from −30 degrees to +30 degrees with respect to the horizon.

Moreover, in this embodiment, the first angle θ1 and the second angle θ2 are individually set at 60 degrees. Hence, in the case where the sensor mounting board 6, that is, the tilt sensor unit 1A is rotated while defining the horizontal direction as 0 degree and the clockwise direction as + in FIG. 17, the respective acceleration sensors 2, 3 and 4 output voltages within a predetermined range when a rotation angle (tilt angle) of the tilt sensor unit 1A is in the following ranges.

First, the first acceleration sensor 2 (characteristic line α) outputs the voltage within the predetermined range when the rotation angle (tilt angle) of the tilt sensor unit 1A is from −180 degrees to −150 degrees, −30 degrees to +30 degrees, and from +150 degrees to +180 degrees.

Moreover, the second acceleration sensor 3 (characteristic line β) outputs the voltage within the predetermined range when the rotation angle of the tilt sensor unit 1A is from −90 degrees to −30 degrees and from +90 degrees to +150 degrees.

Then, the third acceleration sensor 4 (characteristic line γ) outputs the voltage within the predetermined range when the rotation angle of the tilt sensor unit 1A is from −150 degrees to −90 degrees and from +30 degrees to +90 degrees.

As described above, the first angle θ1 and the second angle θ2 are individually set at 60 degrees, whereby, in the case where the tilt sensor unit 1A is rotated (tilted) from −180 degrees to +180 degrees, any of the first, second and third acceleration sensors 2, 3 and 4 outputs the voltage within the predetermined range. Specifically, even if the tilt angle of the tilt sensor unit 1A is any angle from −180 degrees to +180 degrees, the acceleration sensor in the range from −30 degrees to +30 degrees with respect to the horizon is adapted to be usable.

Hence, in this embodiment, in the event where the tilt sensor unit 1A is rotated in the + direction (clockwise direction in FIG. 17) as the one direction, the microcomputer (signal processing unit) 5 selects the acceleration sensors for the tilt angle detection in order from the first acceleration sensor (first detection unit) 2 through the third acceleration sensor (third detection unit) 4 and the second acceleration sensor (second detection unit) 3 to the first acceleration sensor (first detection unit) 2.

Meanwhile, in the event where the tilt sensor unit 1A is rotated in the − direction (counterclockwise direction in FIG. 17) as the reverse direction, the microcomputer (signal processing unit) 5 selects the acceleration sensors for the tilt angle detection in order from the first acceleration sensor (first detection unit) 2 through the second acceleration sensor (second detection unit) 3 and the third acceleration sensor (third detection unit) 4 to the first acceleration sensor (first detection unit) 2.

Specifically, in FIG. 20, in a section (a) from −180 degrees to −150 degrees, the first acceleration sensor 2 is used, in a section (b) from −150 degrees to −90 degrees, the third acceleration sensor 4 is used, and in a section (c) from −90 degrees to −30 degrees, the second acceleration sensor 3 is used. Then, in a section (d) from −30 degrees to +30 degrees, the first acceleration sensor 2 is used. In a similar way, in a section ε from +30 degrees to +90 degrees, the third acceleration sensor 4 is used, and in a section (f) from +90 degrees to +150 degrees, the second acceleration sensor 3 is used, and in a section (g) from +150 degrees to +180 degrees, the first acceleration sensor 2 is used.

Then, the tilt angle is arithmetically operated based on the output voltage (output signal) of the selected acceleration sensor.

Incidentally, in the case where the acceleration sensor selected from among the first, second and third acceleration sensors 2, 3 and 4 indicates a predetermined voltage value within the predetermined range, two types of the tilt angle at which the voltage value concerned is outputted are present (refer to FIG. 20).

Specifically, in the case where the first acceleration sensor 2 is selected, and the predetermined voltage value is detected, then it cannot be determined only by the first acceleration sensor 2 whether the tilt angle of the tilt detection unit 1A is in the section (d) from −30 degrees to +30 degrees, in the section (a) from −180 degrees to −150 degrees or in the section (g) from +150 degrees to +180 degrees.

The same is also applied to the second acceleration sensor 3 (section (c) and section (f)) and the third acceleration sensor 4 (section (b) and section (4)).

Accordingly, in this embodiment, the microcomputer (signal processing unit) 5 is configured to determine the range of the tilt angle of the tilt sensor unit 1A based on the output signals of the two unselected detection units.

Specifically, first, in the case where the first acceleration sensor 2 is selected, and the predetermined voltage value is detected, if the output voltage value of the second acceleration sensor 3 is equal to or more than the upper limit value (that is, is larger than the output voltage value of the first acceleration sensor 2), and the output voltage value of the third acceleration sensor 4 is equal to or less than the lower limit value (that is, is smaller than the output voltage value of the first acceleration sensor 2), then it is determined that the tilt sensor unit 1A is in the section (d). On the contrary, if the output voltage value of the second acceleration sensor 3 is equal to or less than the lower limit value (that is, is smaller than the output voltage value of the first acceleration sensor 2), and the output voltage value of the third acceleration sensor 4 is equal to or more than the upper limit value (that is, is larger than the output voltage value of the first acceleration sensor 2), then it is determined that the tilt sensor unit 1A is in the section (a) or the section (g).

Moreover, in the case where the second acceleration sensor 3 is selected, and the predetermined voltage value is detected, if the output voltage values of both of the first acceleration sensor 2 and the third acceleration sensor 4 are equal to or less than the lower limit value (that is, is smaller than the output voltage value of the second acceleration sensor 3), then it is determined that the tilt sensor unit 1A is in the section (c). On the contrary, if the output voltage values of both of the first acceleration sensor 2 and the third acceleration sensor 4 are equal to or more than the upper limit value (that is, is larger than the output voltage value of the second acceleration sensor 3), then it is determined that the tilt sensor unit 1A is in the section (f).

Then, in the case where the third acceleration sensor 4 is selected, and the predetermined voltage value is detected, if the output voltage values of both of the first acceleration sensor 2 and the second acceleration sensor 3 are equal to or less than the lower limit value (that is, is smaller than the output voltage value of the third acceleration sensor 4), then it is determined that the tilt sensor unit 1A is in the section (b). On the contrary, if the output voltage values of both of the first acceleration sensor 2 and the second acceleration sensor 3 are equal to or more than the upper limit value (that is, is larger than the output voltage value of the third acceleration sensor 4), then it is determined that the tilt sensor unit 1A is in the section (e).

As described above, the respective output voltage values of the first, second and third acceleration sensors 2, 3 and 4 are used. In such a way, in the case where the tilt sensor unit 1A is rotated (tilted) from −180 degrees to +180 degrees, the tilt angle of the tilt sensor unit 1A concerned can be detected accurately.

Also in accordance with this embodiment described above, similar functions and effects to those of the above-mentioned first embodiment can be exerted.

Moreover, in this embodiment, the microcomputer (signal processing unit) 5 is configured to select the acceleration sensor (detection unit), in which the detected output signal is within the predetermined range, from among the first, second and third acceleration sensors (detection units arranged so that the detection axes can be directed in the directions different from one another), and to arithmetically operate the tilt angle based on the output signal of the selected acceleration sensor (detection unit). Therefore, it becomes possible for the microcomputer (signal processing unit) 5 to select the detection unit, which can detect the tilt angle more accurately, from among the detection units among which the range of the accurately detectable tilt angle of the tilt sensor unit 1A differs, and to arithmetically operate the tilt angle based on the output signal of the detection unit concerned.

As described above, also in accordance with this embodiment, it becomes possible to accurately detect the tilt angle of the tilt sensor unit 1A over a wider range.

Moreover, in accordance with this embodiment, the first angle θ1 and the second angle θ2 are individually set at 60 degrees. Therefore, even if the tilt angle of the tilt sensor unit 1A is any angle from −180 degrees to +180 degrees, the acceleration sensor in the range from −30 degrees to +30 degrees with respect to the horizon is adapted to be usable among the first, second and third acceleration sensors 2, 3 and 4. Specifically, the tilt angle of the tilt sensor unit 1A can be accurately detected over 360 degrees. Note that, in the case of setting the first and second angles θ1 and θ2 at the vicinity of 60 degrees, it becomes possible to accurately detect the tilt angle over approximately 360 degrees.

Moreover, in accordance with this embodiment, the microcomputer (signal processing unit) 5 is configured to determine the range of the tilt angle of the tilt sensor unit 1A based on the output signals of the two unselected detection units, and accordingly, angles from −180 degrees to +180 degrees can be accurately detected.

The description has been made above of the preferred embodiments of the present invention; however, the present invention is not limited to the above-described embodiments, and a variety of modifications are possible therefor.

For example, in each of the above-described embodiments, the tilt sensor unit using the first, second and third acceleration sensors (three detection units) has been illustrated; however, plural (two, or four or more) detection units may be provided. At this time, a plurality of the detection units may be provided in one acceleration sensor.

Moreover, in the case of using three or more detection units, it is not necessary to vary the detection axes of all the detection units, and those in which the detection axes are allowed to coincide with each other may be included.

Moreover, in each of the above-described embodiments, the tilt sensor unit has been illustrated, in which the first, second and third acceleration sensors are individually attached onto one plane; however, the respective acceleration sensors may be stacked on one another, and in addition, the directions of the detection axes thereof may be varied. Moreover, the respective acceleration sensors may be mounted on separate boards, and these boards may be arranged vertically while being arranged in parallel to one another.

Moreover, it is also possible to appropriately change specifications (shapes, sizes, layout and the like) of the detection units (acceleration sensors) and other detailed components.

What is claimed is:

1. A tilt sensor unit comprising:
a detection unit that outputs an output signal corresponding to a tilt angle; and
a signal processing unit that arithmetically operates the tilt angle based on the output signal of the detection unit,
wherein a plurality of the detection units are arranged, and in addition, at least two detection units among the plurality of detection units are arranged so that detection axes thereof can be directed in directions different from each other,
the detection units arranged so that the detection axes can be directed in the directions different from one another are arranged so that, even in a case where any of the detection axes of the detection units is made horizontal, other detection axes of the detection units cannot be horizontal in a state where the tilt sensor unit is enabled to detect the tilt angle, and
the signal processing unit arithmetically operates the tilt angle based on an output signal of a detection unit in which a detection axis is nearest a horizon among the detection units arranged so that the detection axes can be directed in the directions different from one another.

2. The tilt sensor unit according to claim 1,
wherein the detection units include:
a first detection unit arranged so that a detection axis thereof can be directed in a predetermined direction;
a second detection unit arranged so that a detection axis thereof can be in a state of being substantially parallel to a plane including the detection axis of the first detection unit, and being rotated by a first angle in one direction with respect to the detection axis of the first detection unit; and
a third detection unit arranged so that a detection axis thereof can be in a state of being substantially parallel to the plane, and being rotated by a second angle in a reverse direction with respect to the detection axis of the first detection unit.

3. The tilt sensor unit according to claim 2,
wherein the signal processing unit:
in an event where the tilt sensor unit arranged so that the detection axis of the first detection unit can be horizontal and that the plane can be a vertical plane is rotated in the one direction, selects the detection units in order from the first detection unit through the third detection unit and the second detection unit to the first detection unit; and
in an event where the tilt sensor unit is rotated in the reverse direction, selects the detection units in order from the first detection unit through the second detection unit and the third detection unit to the first detection unit.

4. The tilt sensor unit according to claim 3, wherein the signal processing unit determines a range of the tilt angle of the tilt sensor unit based on the output signals of the two unselected detection units.

5. The tilt sensor unit according to claim 2, wherein the first angle and the second angle are individually set at a vicinity of 30 degrees.

6. The tilt sensor unit according to claim 2, wherein the first angle and the second angle are individually set at a vicinity of 60 degrees.

7. The tilt sensor unit according to claim 1, wherein the plurality of detection units are arranged on a front surface of one board.

8. The tilt sensor unit according to claim 7,
wherein the board has a substantially square shape, and
the plurality of detection units are arranged on a center portion of the front surface of the board or on a line that passes through a center of the front surface of the board and is substantially parallel to a side of the board.

9. The tilt sensor unit according to claim 1, wherein the detection units are electrostatic capacitance-type acceleration sensors.

10. The tilt sensor unit according to claim 9, wherein the electrostatic capacitance-type acceleration sensors are 1-axis acceleration sensors.

11. A tilt sensor unit comprising:
a detection unit that outputs an output signal corresponding to a tilt angle; and
a signal processing unit that arithmetically operates the tilt angle based on the output signal of the detection unit,
wherein a plurality of the detection units are arranged, and in addition, at least two detection units among the plurality of detection units are arranged so that detection axes thereof can be directed in directions different from each other,
the detection units arranged so that the detection axes can be directed in the directions different from one another are arranged so that, even in a case where any of the detection axes of the detection units is made horizontal, other detection axes of the detection units cannot be horizontal in a state where the tilt sensor unit is enabled to detect the tilt angle, and
the signal processing unit selects a detection unit in which a detected output signal is within a predetermined range from among the detection units arranged so that the detection axes can be directed in the directions different from one another, and arithmetically operates the tilt angle based on the output signal of the selected detection unit.

12. The tilt sensor unit according to claim 11,
wherein the detection units include:
a first detection unit arranged so that a detection axis thereof can be directed in a predetermined direction;
a second detection unit arranged so that a detection axis thereof can be in a state of being substantially parallel to a plane including the detection axis of the first detection unit, and being rotated by a first angle in one direction, with respect to the detection axis of the first detection unit; and
a third detection unit arranged so that a detection axis thereof can be in a state of being substantially parallel to the plane, and being rotated by a second angle in a reverse direction with respect to the detection axis of the first detection unit.

13. The tilt sensor unit according to claim 12,
wherein the signal processing unit:
in an event where the tilt sensor unit arranged so that the detection axis of the first detection unit can be horizontal and that the plane can be a vertical plane is rotated in the one direction, selects the detection units in order from the first detection unit through the third detection unit and the second detection unit to the first detection unit; and
in an event where the tilt sensor unit is rotated in the reverse direction, selects the detection units in order from the first detection unit through the second detection unit and the third detection unit to the first detection unit.

14. The tilt sensor unit according to claim 13, wherein the signal processing unit determines a range of the tilt angle of the tilt sensor unit based on the output signals of the two unselected detection units.

15. The tilt sensor unit according to claim 12, wherein the first angle and the second angle are individually set at a vicinity of 30 degrees.

16. The tilt sensor unit according to claim 12, wherein the first angle and the second angle are individually set at a vicinity of 60 degrees.

17. The tilt sensor unit according to claim 11, wherein the plurality of detection units are arranged on a front surface of one board.

18. The tilt sensor unit according to claim 17,
wherein the board has a substantially square shape, and
the plurality of detection units are arranged on a center portion of the front surface of the board or on a line that passes through a center of the front surface of the board and is substantially parallel to a side of the board.

19. The tilt sensor unit according to claim 11, wherein the detection units are electrostatic capacitance-type acceleration sensors.

20. The tilt sensor unit according to claim 19, wherein the electrostatic capacitance-type acceleration sensors are 1-axis acceleration sensors.
